(19) United States
(12) Patent Application Publication
(10) Pub. No.: US 2024/0413432 A1
(43) Pub. Date: Dec. 12, 2024

(54) BATTERY PACK

(71) Applicant: HONDA MOTOR CO., LTD., Tokyo (JP)

(72) Inventors: Ryo ISHIZAKI, Saitama (JP); Ken Yasui, Saitama (JP); Masaaki Tatsuwaki, Saitama (JP)

(73) Assignee: HONDA MOTOR CO., LTD., Tokyo (JP)

(21) Appl. No.: 18/582,688

(22) Filed: Feb. 21, 2024

(30) Foreign Application Priority Data
Mar. 24, 2023 (JP) 2023-048060

(51) Int. Cl. H01M 10/6568; H01M 10/613; H01M 10/625; H01M 10/658; H01M 50/244; H01M 50/249; H01M 50/264

(52) U.S. Cl. CPC H01M 10/6568; H01M 10/613; H01M 10/625; H01M 10/658; H01M 50/244; H01M 50/249; H01M 50/264

(57) ABSTRACT

A battery pack is attached under a floor of a vehicle. The battery pack has battery, a battery case including a bottom plate on which the battery is mounted, and a water jacket configured to allow a refrigerant for cooling the battery to flow therethrough. The water jacket is provided with a flow path defined by the bottom plate and a water jacket plate disposed below the bottom plate. The water jacket plate is integrally provided with a protruding portion extending in a front-rear direction of the vehicle and protruding downward. The protruding portion includes a first protruding portion disposed on an outer side with respect to the water jacket in a vehicle width direction and protruding downward with respect to the water jacket.

### CROSS-REFERENCE TO RELATED APPLICATIONS

This application is based on and claims priority under 35 USC 119 from Japanese Patent Application No. 2023-048060 filed on Mar. 24, 2023, the entire content of which is incorporated herein by reference.

### TECHNICAL FIELD

The present disclosure relates to a battery pack to be attached under a floor of a vehicle.

### BACKGROUND ART

In recent years, researches and developments have been conducted on a secondary battery (hereinafter, also referred to as a battery) that contributes to improvement in energy efficiency in order to allow more users to access affordable, reliable, sustainable, and advanced energy.

A large-capacity battery is mounted on an electric vehicle such as a battery type electric automobile. The battery is attached, for example, under a floor of the vehicle in a state of being housed in a battery case, but when a curb, a flying stone, or the like collides with the battery case during traveling, a structure for protecting the battery from a load input due to the collision is required.

On the other hand, in a vehicle body lower structure described in JP2021-138187A, for example, a protection plate is disposed below a battery case, and a projection is provided on a bottom plate of the battery case or the protection plate at a position below an intermediate plate of a battery stack.

In JP2021-138187A, a flow path through which a coolant flows is provided in the bottom plate of the battery case. Since the projection of JP2021-138187A is provided on a central portion in a vehicle width direction, when a curb or the like comes into contact with the battery case from the side and below of the vehicle, there is a concern that the flow path may not be appropriately protected. In JP2021-138187A, the protection plate is disposed below the battery case in order to protect the battery case, but the number of components increases and a weight of the vehicle increases accordingly.

### SUMMARY OF INVENTION

The present disclosure provides a battery pack capable of protecting a water jacket disposed below a battery, and reducing the number of components and a weight of a vehicle.

An aspect of the present disclosure relates to a battery pack to be attached under a floor of a vehicle, the battery pack including:
a battery;
a battery case including a bottom plate on which the battery is mounted; and
a water jacket configured to allow a refrigerant for cooling the battery to flow therethrough,
in which the water jacket is provided with a flow path defined by the bottom plate and a water jacket plate disposed below the bottom plate,
the water jacket plate is integrally provided with a protruding portion extending in a front-rear direction of the vehicle and protruding downward, and
the protruding portion includes a first protruding portion disposed on an outer side with respect to the water jacket in a vehicle width direction and protruding downward with respect to the water jacket.

According to the present disclosure, it is possible to protect the water jacket disposed below the battery, and to reduce the number of components and a weight of the vehicle.

### BRIEF DESCRIPTION OF DRAWINGS

Exemplary embodiment(s) of the present invention will be described in detail based on the following figures, wherein:

FIG. 1 is a perspective view of a battery pack 1 and a vehicle V on which the battery pack 1 is mounted;

FIG. 2 is an exploded perspective view of the battery pack 1;

FIG. 3 is a top view showing an internal structure of the battery pack 1;

FIG. 4 is a bottom view of a base plate 30;

FIG. 5 is a cross-sectional view taken along a line A-A of FIG. 3; and

FIG. 6 is a cross-sectional view taken along a line B-B of FIG. 3.

### DESCRIPTION OF EMBODIMENTS

Hereinafter, a battery pack according to an embodiment of the present disclosure will be described with reference to the accompanying drawings. The drawings are viewed from directions of reference numerals, and in the following description, directions such as front, rear, left, right, upper, and lower directions are described according to a direction viewed from a driver of a vehicle. In the drawings, a front side of the vehicle is denoted by Fr, a rear side is denoted by Rr, a left side is denoted by L, a right side is denoted by R, an upper side is denoted by U, and a lower side is denoted by D. Further, a left-right direction is also referred to as a vehicle width direction.

### (Battery Pack)

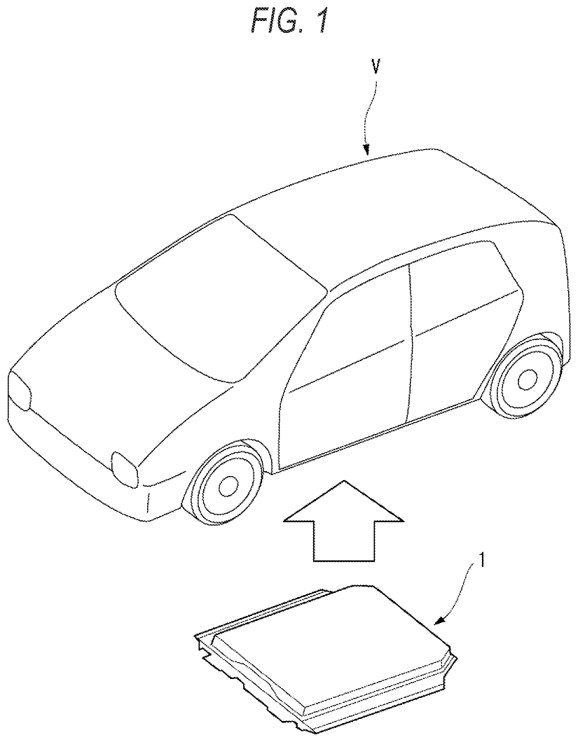

As shown in FIG. 1, a battery pack 1 according to an embodiment of the present disclosure is mounted on a vehicle V. The vehicle V is an electric vehicle such as a battery type electric automobile, a hybrid vehicle, or a fuel cell vehicle. The battery pack 1 is attached under a floor of the vehicle V.

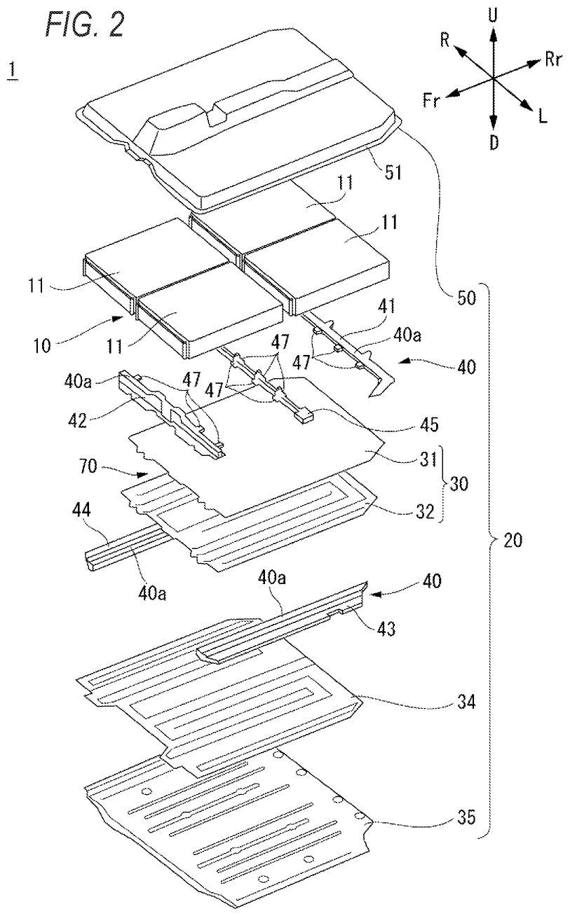

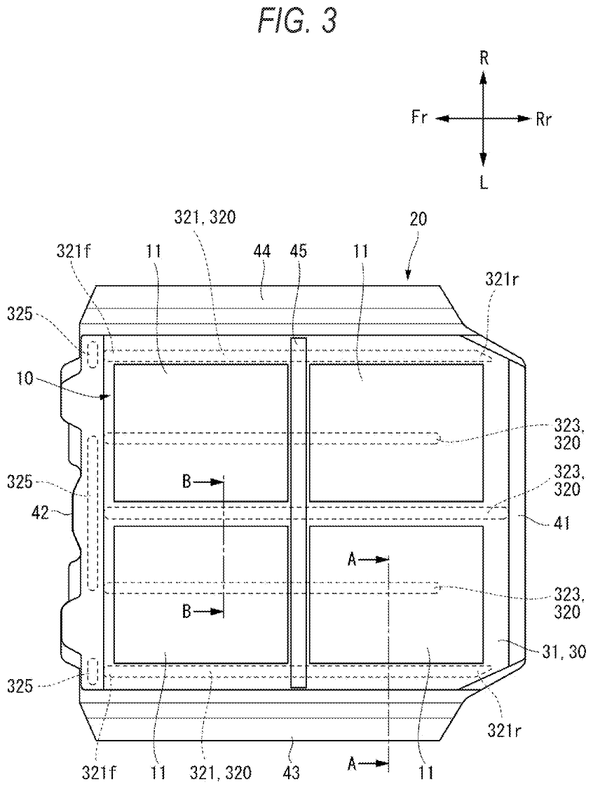

As shown in FIGS. 2 and 3, the battery pack 1 includes four battery modules 11, a battery case 20 that houses the battery modules 11, and a water jacket 70 that cools the battery modules 11.

The four battery modules 11 are arranged in two rows in a front-rear direction and in two rows in a left-right direction. The four battery modules 11 are electrically connected to one another via an electrical connection member (for example, a bus bar) (not shown). The battery modules 11 store electric power to be supplied to a motor or the like serving as a drive source of the vehicle V. The number of battery modules 11 can be freely set, and an arrangement is also not particularly limited.

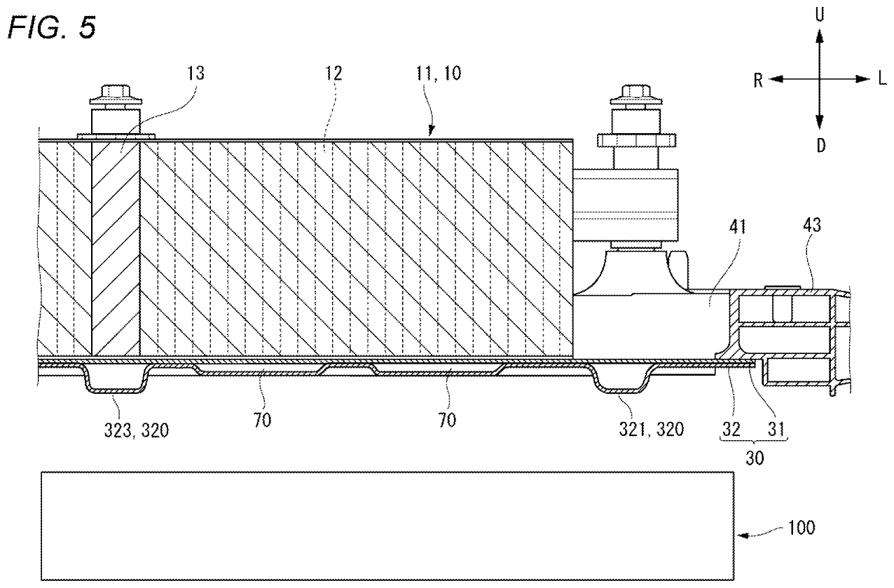

As shown in FIG. 5, each battery module 11 includes a plurality of battery cells 12. The battery cell 12 is, for example, a square cell, a laminated cell, or a cylindrical cell. In the present embodiment, the plurality of battery cells 12 are laminated in a vehicle width direction, and an intermediate plate 13 is provided at a central portion of the laminated plurality of battery cells 12 in the vehicle width direction. Here, in the following description, the four battery modules 11 may be collectively referred to as a battery 10.

Returning to FIGS. 2 and 3, the battery case 20 includes a base plate 30 on which the battery 10 is placed, a frame member 40 constituting an outer frame of the battery case 20, and a cover 50 covering the battery 10.

The base plate 30 is formed, for example, by pressing a metal material such as aluminum. The base plate 30 includes a bottom plate 31 on which the battery 10 is placed and a water jacket plate 32 disposed below the bottom plate 31, and is implemented by two plates overlapping in an upper-lower direction. Outer edges of the bottom plate 31 and the water jacket plate 32 are joined by, for example, brazing. The water jacket 70 is formed between the bottom plate 31 and the water jacket plate 32. The details of the water jacket 70 and the water jacket plate 32 will be described later.

A heat insulator 34 made of, for example, foamed polypropylene is attached to the base plate 30 from below, and covers the water jacket 70 from below. Further, a lower cover 35 is attached to the base plate 30 from below the heat insulator 34. The lower cover 35 is made of, for example, resin.

The frame member 40 is joined to an outer edge of the base plate 30 and constitutes the outer frame (that is, a rear wall, a front wall, a left wall, and a right wall) of the battery case 20. The frame member 40 is, for example, an aluminum casting. The frame member 40 includes a rear cross member 41 provided at a rear edge of the base plate 30, a front cross member 42 provided at a front edge of the base plate 30, and a pair of side frames 43 and 44 (also referred to as a left side frame 43 and a right side frame 44) provided at left and right edges of the base plate 30. The rear cross member 41 and the front cross member 42 extend in the left-right direction, and the pair of side frames 43 and 44 extend in the front-rear direction. The rear cross member 41 and the front cross member 42 are connected to the pair of side frames 43 and 44 by welding or the like.

The rear cross member 41 and the front cross member 42 are each provided with fixing portions 47 for fixing the battery 10 to the base plate 30 and the frame member 40. The rear cross member 41, the front cross member 42, and the pair of side frames 43 and 44 are each provided with a fastening portion to be fastened to a vehicle body by a bolt or the like.

The frame member 40 further includes a central cross member 45 extending in the left-right direction and provided at a central portion of the base plate 30 in the front-rear direction. The central cross member 45 is disposed between the two battery modules 11 disposed on a front side and the two battery modules 11 disposed on a rear side. Similarly to the rear cross member 41 and the front cross member 42, the central cross member 45 is provided with fixing portions 47 to which the battery 10 is fixed. The central cross member 45 is connected to the pair of side frames 43 and 44 by welding or the like.

The cover 50 is attached to the frame member 40. A sealing member is provided between an upper surface 40a of the frame member 40 and an outer edge 51 of the cover 50, and the cover 50 is attached to the upper surface 40a of the frame member 40, thereby sealing an inside of the battery case 20. The cover 50 is attached to the frame member 40 by, for example, a bolt.

### (Water Jacket)

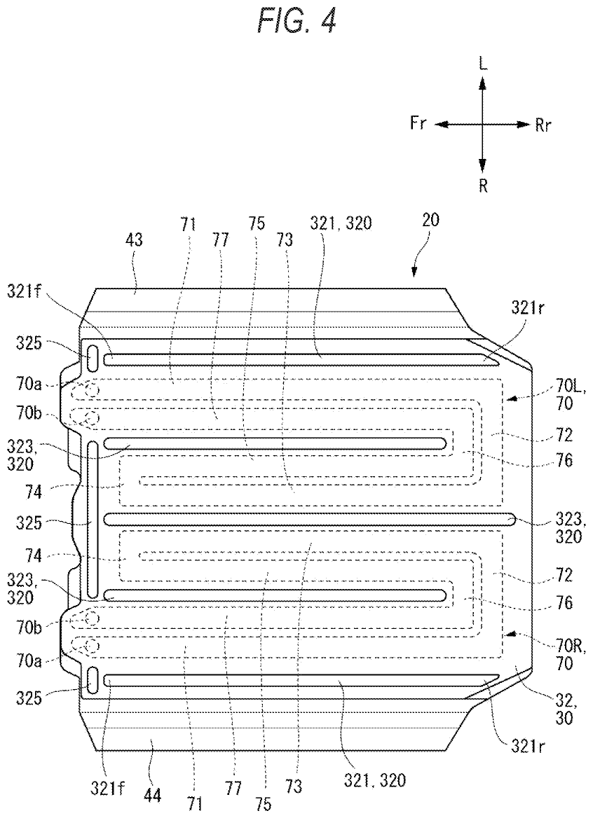

Next, the details of the water jacket 70 will be described. FIG. 4 is a bottom view of the base plate 30, and the water jacket 70 is indicated by a broken line.

The water jacket 70 is implemented by a flow path defined by the bottom plate 31 and the water jacket plate 32, and a refrigerant (for example, cooling water) for cooling the battery 10 flows therein. The water jacket 70 includes a left water jacket 70L provided on a left side of the battery case 20 and a right water jacket 70R provided on a right side of the battery case 20. The left water jacket 70L and the right water jacket 70R have bilaterally symmetrical shapes.

A supply port 70a and a discharge port 70b are provided at a front end of each of the water jackets 70L and 70R. A hose (not shown) is connected to the supply port 70a and the discharge port 70b, the refrigerant is supplied from the supply port 70a to each of the water jackets 70L and 70R, and the refrigerant is discharged from the discharge port 70b to the outside.

Each of the water jackets 70L and 70R has a plurality of flow paths 71, 73, 75, and 77 extending in the front-rear direction and a plurality of flow paths 72, 74, and 76 extending in the left-right direction. The flow path 71 has the supply port 70a at a front end thereof and extends from the supply port 70a along the left edge or the right edge of the base plate 30. The flow path 73 extends in the central portion of the base plate 30 with respect to the flow path 71. The flow path 71 and the flow path 73 are connected by the flow path 72 at rear ends thereof. The flow path 75 and the flow path 77 are provided between the flow path 71 and the flow path 73, the flow path 75 is provided next to the flow path 73, and the flow path 77 is provided next to the flow path 71. The flow path 73 and the flow path 75 are connected by the flow path 74 at front ends thereof. The flow path 75 and the flow path 77 are connected by the flow path 76 at rear ends thereof. The flow path 77 has the discharge port 70b at a front end thereof.

As shown in FIGS. 3 and 4, the water jacket plate 32 is integrally provided with a protruding portion 320 protruding downward. The protruding portion 320 includes outer protruding portions 321 extending in the front-rear direction and disposed on an outer side with respect to the water jacket 70 in the vehicle width direction, inner protruding portions 323 extending in the front-rear direction and disposed on an inner side with respect to the outer protruding portions 321 in the vehicle width direction, and front end protruding portions 325 extending in the vehicle width direction and disposed at a front end of the water jacket plate 32.

The outer protruding portions 321 are provided between the water jacket 70 and the left side frame 43 and between the water jacket 70 and the right side frame 44 in the vehicle width direction. More specifically, the outer protruding portions 321 are provided between the battery 10 and the left side frame 43 and between the battery 10 and the right side frame 44 in the vehicle width direction. The outer protruding portion 321 extends from the front end to a rear end of the water jacket plate 32, and the battery 10 is disposed between a front end 321f and a rear end 321r of the outer protruding portion 321 in the front-rear direction.

Three inner protruding portions 323 are provided between the left and right outer protruding portions 321 and extend in the front-rear direction. The three inner protruding portions 323 are respectively arranged between adjacent flow paths, specifically, between the flow path 75 and the flow path 77 of the left water jacket 70L, between the flow path 73 of the left water jacket 70L and the flow path 73 of the right water jacket 70R, and between the flow path 75 and the flow path 77 of the right water jacket 70R.

The outer protruding portions 321 and the inner protruding portions 323 are arranged orthogonally to the rear cross member 41, the front cross member 42, and the central cross member 45. Specifically, in the present embodiment, the outer protruding portions 321 are arranged orthogonally to the front cross member 42 and the central cross member 45.

Among the inner protruding portions 323, the central inner protruding portion 323 is disposed orthogonally to the rear cross member 41, the front cross member 42, and the central cross member 45, and the remaining inner protruding portions 323 are arranged orthogonally to the front cross member 42 and the central cross member 45. With such a configuration, a rigidity of the battery case 20 is increased, and thus a vibration of the battery 10 can be prevented during traveling of the vehicle V.

Three front end protruding portions 325 are provided in front of the outer protruding portions 321 and the inner protruding portions 323. By providing the front end protruding portions 325, the rigidity of the battery case 20 can be increased.

FIG. 5 is a cross-sectional view taken along a line A-A of FIG. 3. The heat insulator 34 and the lower cover 35 are not shown. As shown in FIG. 5, the outer protruding portion 321 and the inner protruding portion 323 protrude downward with respect to the water jacket 70. According to such a configuration, for example, when an object 100 such as a curb collides with the battery pack 1 from below and a load is input, the load is input to the outer protruding portion 321 and/or the inner protruding portion 323 before the load is input to the water jacket 70. Accordingly, the water jacket 70 can be protected against the load applied from below the battery pack 1. In particular, since the outer protruding portion 321 is disposed on the outer side with respect to the water jacket 70 in the vehicle width direction, the water jacket 70 can be protected even when the object 100 collides with the battery pack 1 from the side and below and a load is input. Consequently, the battery 10 disposed above the water jacket 70 can be protected.

As shown in FIG. 3, the battery 10 is disposed between the front end 321f and the rear end 321r of the outer protruding portion 321 in the front-rear direction, and thus even when the load is input from the side and below of the vehicle V, the input to the battery 10 can be further reduced.

As shown in FIG. 5, the outer protruding portion 321 is provided on an outer side with respect to the battery 10 in the vehicle width direction, and in other words, the battery 10 is not provided directly above the outer protruding portion 321. Therefore, even when the object 100 collides with the battery pack 1 from below and an upward load is applied to the outer protruding portion 321, the input to the battery 10 can be further reduced.

The inner protruding portion 323 is disposed directly below the intermediate plate 13 of the battery module 11. Therefore, even when the object 100 collides with the battery pack 1 from below and the upward load is applied to the inner protruding portion 323, the load can be received by the intermediate plate 13 having a large load capacity, and thus the battery cells 12 can be protected.

The protruding portion 320 is provided integrally with the water jacket plate 32, and thus it is not necessary to provide, for example, a high-strength metal protection plate below the water jacket plate 32 in order to protect the water jacket 70, and the number of components can be reduced. In addition, it is not necessary to make the water jacket plate 32 thick or to make the lower cover 35 of a high-strength metal, and a weight can be reduced.

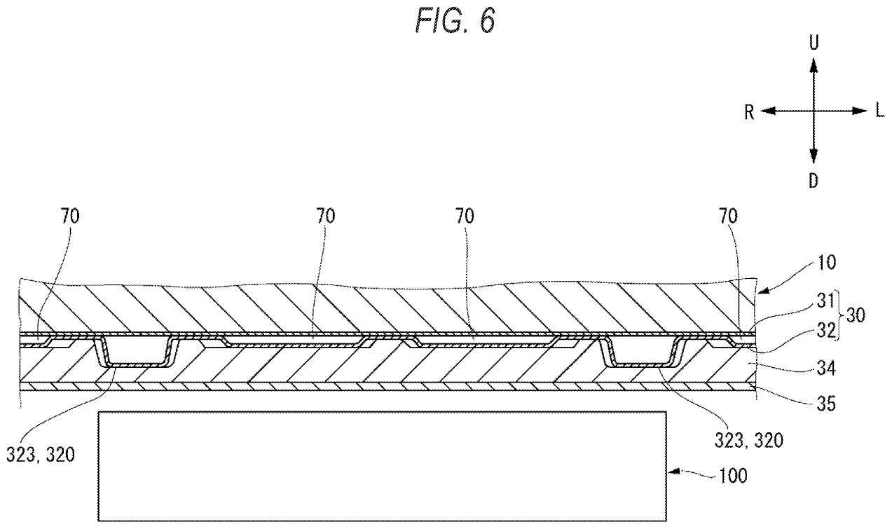

FIG. 6 is a cross-sectional view taken along a line B-B of FIG. 3. As shown in FIG. 6, the heat insulator 34 covers the water jacket 70 and the protruding portion 320 from below. The heat insulator 34 has a function of receiving a local load input from directly below the battery pack 1 due to, for example, a collision with a flying stone or the like before the load is input to the water jacket 70 and the protruding portion 320, and dispersing the load. In this way, by providing the heat insulator 34 with not only a heat insulating function of the water jacket 70 but also a load dispersing function, the number of components and the weight can be reduced. In addition, since the heat insulator 34 also covers the protruding portion 320 from below, a load input to the protruding portion 320 is also dispersed, and a deformation of the protruding portion 320 due to the load input can be prevented.

Although an embodiment of the present disclosure has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the components in the above embodiment may be freely combined without departing from the gist of the invention.

For example, in the above embodiment, the heat insulator 34 covers the water jacket 70 and the protruding portion 320 from below, but the present invention is not limited thereto. For example, the heat insulator 34 may cover only the water jacket 70 from below and may not cover the protruding portion 320 from below. Even with such a configuration, the heat insulator 34 can receive the local load input from directly below the battery pack 1 before the load is input to the water jacket 70, and can disperse the load.

In the present description, at least the following matters are described. In parentheses, corresponding components and the like in the above embodiment are shown as an example, but the present invention is not limited thereto.
(1) A battery pack (battery pack 1) to be attached under a floor of a vehicle (vehicle V), the battery pack including:
a battery (battery 10);
a battery case (battery case 20) including a bottom plate (bottom plate 31) on which the battery is mounted; and
a water jacket (water jacket 70) configured to allow a refrigerant for cooling the battery to flow therethrough,
in which the water jacket is provided with a flow path defined by the bottom plate and a water jacket plate (water jacket plate 32) disposed below the bottom plate,
the water jacket plate is integrally provided with a protruding portion (protruding portion 320) extending in a front-rear direction of the vehicle and protruding downward, and
the protruding portion includes a first protruding portion (outer protruding portion 321) disposed on an outer side with respect to the water jacket in a vehicle width direction and protruding downward with respect to the water jacket.

According to (1), when a load is input to the battery pack from the side and below of the vehicle, the load is received by the first protruding portion disposed on the outer side with respect to the water jacket, so that the water jacket can be protected. As a result, the battery disposed above the water jacket can also be protected. Further, since the protruding portion is provided integrally with the water jacket plate, it is possible to protect the water jacket and the battery and to reduce the number of components and a weight.
(2) The battery pack according to (1),
in which the battery is disposed on an inner side with respect to both ends (front end 321f and rear end 321r) of the first protruding portion in the front-rear direction.

According to (2), it is possible to improve a protection performance of the battery against a load input from the side of the vehicle.
(3) The battery pack according to (1) or (2), further including:
a heat insulator (heat insulator 34) covering the water jacket from below.

According to (3), a local load input from directly below the water jacket is dispersed in the heat insulator. Therefore, the load input to the water jacket can be further prevented. In addition, since the heat insulator has both a heat insulating function and a load dispersing function, it is possible to reduce the number of components and the weight.
(4) The battery pack according to (3),
in which the heat insulator covers the water jacket and the protruding portion from below.

According to (4), a local load input from directly below the protruding portion is dispersed in the heat insulator, and thus a deformation of the protruding portion can be prevented.
(5) The battery pack according to any one of (1) to (4),
in which the battery case includes:
   a pair of side frames (a pair of side frames 43 and 44) joined to the bottom plate and facing each other in the vehicle width direction; and
   at least one cross member (rear cross member 41, front cross member 42, central cross member 45) extending in the vehicle width direction and connecting the pair of side frames,
the side frames are to be connected to a vehicle body,
the protruding portion further includes a second protruding portion (inner protruding portion 323) disposed on an inner side with respect to the first protruding portion in the vehicle width direction and protruding downward with respect to the water jacket, and
the first protruding portion and the second protruding portion are orthogonal to the at least one cross member in a top view.

According to (5), since the first protruding portion and the second protruding portion are orthogonal to the cross member, a vibration of the battery can be prevented during traveling of the vehicle.
(6) The battery pack according to any one of (1) to (5),
in which the water jacket includes a plurality of flow paths (flow paths 71, 73, 75, 77) extending in the front-rear direction, and
the protruding portion further includes a second protruding portion (inner protruding portion 323) disposed between the adjacent flow paths and protruding downward with respect to the water jacket.

According to (6), when a load is input to the battery pack from below the vehicle, the load is also received by the second protruding portion in addition to the first protruding portion, and thus it is possible to improve a protection performance of the water jacket.
(7) The battery pack according to any one of (1) to (6),
in which the first protruding portion is disposed on an outer side with respect to the battery in the vehicle width direction.

According to (7), when a load is input to the first protruding portion from below the vehicle, the load applied to the battery can be reduced.

What is claimed is:

1. A battery pack to be attached under a floor of a vehicle, the battery pack comprising:
a battery;
a battery case including a bottom plate on which the battery is mounted; and
a water jacket configured to allow a refrigerant for cooling the battery to flow therethrough,
wherein the water jacket is provided with a flow path defined by the bottom plate and a water jacket plate disposed below the bottom plate,
the water jacket plate is integrally provided with a protruding portion extending in a front-rear direction of the vehicle and protruding downward, and
the protruding portion includes a first protruding portion disposed on an outer side with respect to the water jacket in a vehicle width direction and protruding downward with respect to the water jacket.

2. The battery pack according to claim 1,
wherein the battery is disposed on an inner side with respect to both ends of the first protruding portion in the front-rear direction.

3. The battery pack according to claim 1, further comprising:
a heat insulator covering the water jacket from below.

4. The battery pack according to claim 3,
wherein the heat insulator covers the water jacket and the protruding portion from below.

5. The battery pack according to claim 1,
wherein the battery case includes:
a pair of side frames joined to the bottom plate and facing each other in the vehicle width direction; and
at least one cross member extending in the vehicle width direction and connecting the pair of side frames,
the side frames are to be connected to a vehicle body,
the protruding portion further includes a second protruding portion disposed on an inner side with respect to the first protruding portion in the vehicle width direction and protruding downward with respect to the water jacket, and
the first protruding portion and the second protruding portion are orthogonal to the at least one cross member in a top view.

6. The battery pack according to claim 1,
wherein the water jacket includes a plurality of flow paths extending in the front-rear direction, and
the protruding portion further includes a second protruding portion disposed between the adjacent flow paths and protruding downward with respect to the water jacket.

7. The battery pack according to claim 1,
wherein the first protruding portion is disposed on an outer side with respect to the battery in the vehicle width direction.
